(19) United States
(12) Patent Application Publication
(10) Pub. No.: US 2004/0020902 A1
(43) Pub. Date: Feb. 5, 2004

(54) Multi-axis laser apparatus and process for cutting and welding

(76) Inventors: Edward D. McCoy, San Clemente, CA (US); Phillip Sylvester, San Clemente, CA (US)

Correspondence Address: ALLEN D. BRUFSKY, P.A., 4140 GORDON DRIVE, NAPLES, FL, 34102, US

(21) Appl. No.: 10/208,098

(22) Filed: Jul. 30, 2002

(51) Int. Cl. B23K 26/20; B23K 26/38

(52) U.S. Cl. 219/121.6; 219/121.63; 219/121.67

(57) ABSTRACT

A system and enclosure for cutting or welding a workpiece has a laser beam to effect the cut or weld which can be focused about a Z-axis, and controlled for movement relative to the workpiece about an A (linear) and B (rotary) axis. The workpiece is held for movement relative to the beam about an X (linear) and Y (rotary) axis.

### BACKGROUND OF THE INVENTION

1. Field of the Invention

This invention relates to a method and apparatus utilizing a laser beam to cut and weld small parts or workpieces, and more particularly, a method and apparatus having at least four degrees of motion to effect relative movement of the beam relative to the workpiece.

2. Description of the Prior Art

Most automated, computer-driven apparatus for effecting a weld or cut on a small workpiece have three degrees of movement, namely an X-axis for linear movement of the workpiece relative to the beam, a Y or rotary axis to effect rotation of the workpiece relative to the beam around the X-axis, and a Z-axis or height adjustment of the beam focusing mechanism. Such an apparatus is fully disclosed in my copending application, filed Jul. 30, 2002 entitled “Multi-Axis Laser Apparatus and Process for the Fine Cutting of Tubing” assigned to the same assignee as the present invention, which disclosure is incorporated herein by reference. The workpiece being produced in my copending application is a stent or tube with a particular pattern cut in its walls to provide flexibility and radial expansion when implanted in an artery after angioplasty surgery. However, in certain applications, particularly those involving the welding of small parts or workpieces, additional degrees of movement must be provided in the apparatus, for example to move the laser beam used to cut or weld in a rotary fashion (or around the A-axis) and back and forth in a linear movement (B-axis), to effect a software-implemented computer controlled cut or weld.

### SUMMARY OF THE INVENTION

Accordingly, the proposed invention discloses an improved system for cutting and welding small workpieces movable on a table below a laser beam mounting a cutting and welding support block for movement of the workpiece about an X and Y axis relative to the cutting or welding beam. The beam is focused and a camera system can be provided movable along a Z-axis mounting assembly to focus the beam through a series of lenses and to view the work area. Additionally, the beam can be rotated around its own axis (or A-axis) and moved in a linear manner (along a B-axis) in response to a preprogrammed software generated signal simultaneously or sequentially relative to movement along the X and Y axes, for example when necessary in many welding and even in some cutting applications.

The motion imparted to the positioning equipment connected to the beam and workpiece is engendered by a rotary and linear encoder mechanism directing linear and rotary motion in response to input of coordinates on a computer which in conjunction with software generated signals move the workpiece along the X and Y axes and beam along the A and B axes to effect the requisite weld or cut in a predetermined pattern and location.

The apparatus is also enclosed within a glove box enclosure, whose atmosphere can be evacuated to create a vacuum or whose interior can be flooded with an inert gas since certain applications require handling the workpiece in either a sterile environment or welding of certain metals require an inert atmosphere.

### BRIEF DESCRIPTION OF THE DRAWINGS

Further objects and advantages of the invention will become more apparent from the following description and claims, and from the accompanying drawings, wherein:

FIG. 1 is a schematic block diagram which illustrates the components used in the practice of the invention; and

FIG. 2 is a perspective view of the enclosure for the components illustrated in FIG. 1.

### DETAILED DESCRIPTION OF THE PREFERRED EMBODIMENT

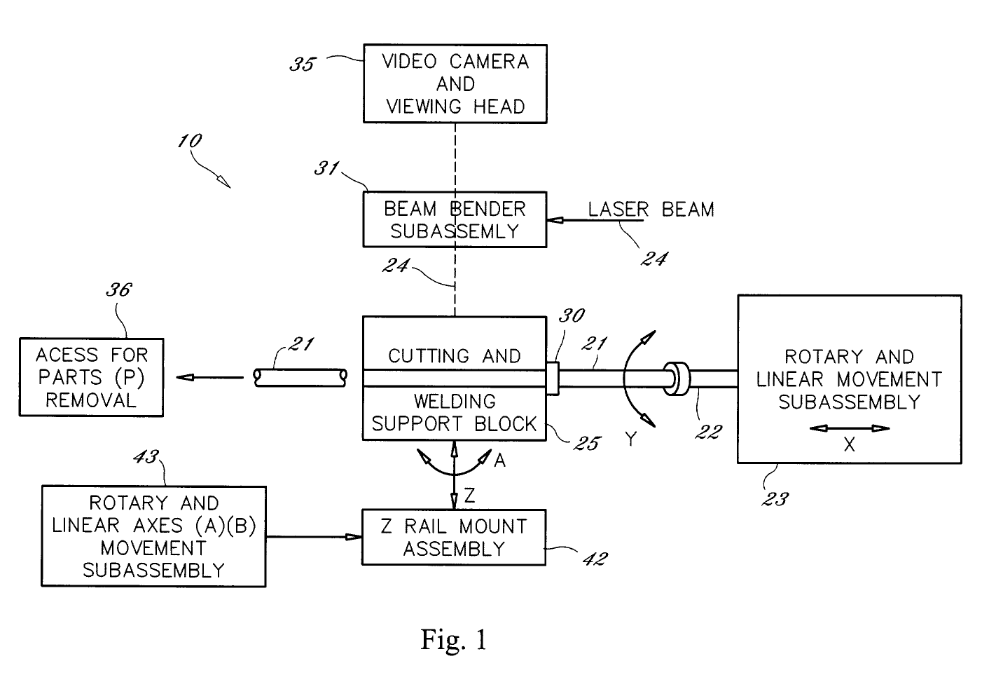

Referring now to the drawings in detail, wherein like numerals indicate like elements throughout the several views, there is shown in FIG. 1 the overall process and apparatus 10, in accordance with the invention.

In order to successfully achieve the desired end results, a workpiece 21 to be welded or cut can be placed in a rotatable collet fixture 22 of a computer software controlled rotary and linear movement subassembly apparatus 23 for positioning the workpiece 21 relative to a focused laser beam 24. According to encoded instructions, the tubing 21 is rotated and moved longitudinally relative to the laser beam 24. The laser beam 24 cuts or welds the workpiece by ablation and a pattern is cut into the workpiece 21. The process of cutting or welding is automated except for loading and unloading the workpiece 21. It may be done, for example, using computer-operated software in conjunction with the opposed collet fixture 22 and a rotatable and linearly movable clamp mechanism 30 mounted on the cutting and welding block subassembly 25 enabling axial rotation of a length of the workpiece, along with an X-axis table (not shown) driven by a computer controlled linear motor to move the workpiece 21 axially relatively to laser beam 24, as described. A motorized Z-rail mount subassembly 42 may be used to focus the laser beam 24 relative to focusing lenses in cutting block subassembly 25 and to move into focus a video camera and viewing head 35 to spot the laser beam on the workpiece 21 the cutting block subassembly can be provided with LEDs. The positioning of the tubing relative to the laser beam by the rotary and linear movement subassembly 23 requires the use of precision computer software operated equipment such as that manufactured and sold by Dr. Johanne's Heidenhain GmbH, D-83301, Trannrout Germany, having a rotary encoder mechanism for controlling the rotary movement of collet 22, through which one end of the workpiece 21 is inserted. Alternatively, the workpiece 21 may be held on a flat table which is rotated and moved linearly, as described above. The unique rotary encoder mechanism allows the computer program to be written as if the pattern were being cut from a flat sheet which allows both circular and linear interpolation to be utilized in programming. The linear encoder mechanism and motor sold by RSF Electronik GmbH, A-5121, Tarsdorf, Germany positions the X-axis table against the spring force of a bellows (not shown) in accordance with the prescribed software program so that the combination of rotary (Y-axis) and linear (X-axis) movements of the workpiece 21 relative to the cutting laser beam 24 cuts or welds the precise pattern in workpiece 21 moved in the X and Y direction relative to the beam.

An optical system comprising a beam bender subassembly 31 delivers and focuses the beam onto the surface of the tube 21 in a well-known manner.

A video camera and viewing head 35 along with a focusing lens 36 can be used to control the width of the beam and spot the beam to effect precision welding and cutting.

Additionally, the beam 24 can be rotated around its own axis (or A-axis) and moved in a linear manner (along a B-axis) in response to the preprogrammed software generated signal which will trace the workpiece's geometry to simultaneously or sequentially provide relative movement along the X and Y axes, for example which is necessary in many welding and even in some cutting applications. The same equipment type as subassembly 23 can be employed at 43 in conjunction with and connected to the Z-axis rail mount assembly 42 to effect the programmed movement along the A and B axes.

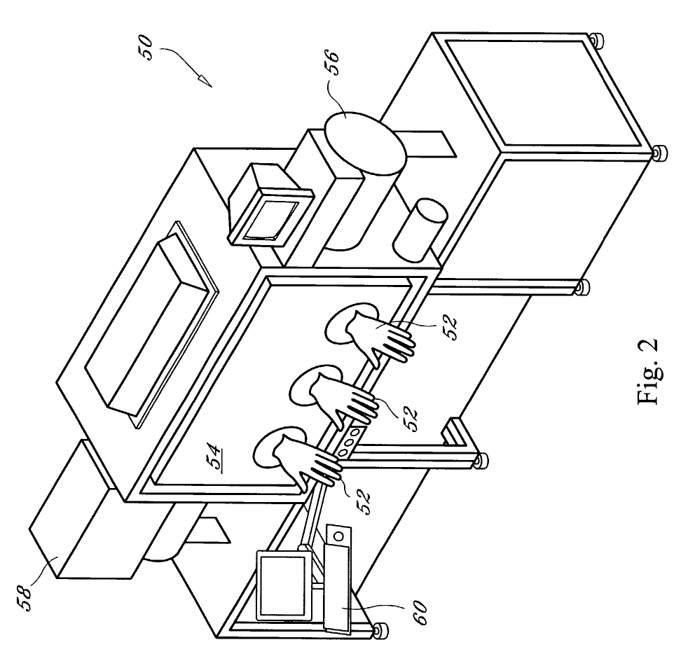

The apparatus is also enclosed within a glove box enclosure 50, shown in FIG. 2, provided with gloves 52 protruding from a glass window 54 on enclosure 50, whose atmosphere can be evacuated by a pump 56 or the like to create a vacuum or which can be used to flood the interior of enclosure 50 with an inert gas, since certain applications require handling the workpiece in either a sterile environment or welding of certain metals require an inert atmosphere. Oven equipment 58 can also be provided for baking the workpiece 21 in enclosure 50, and the workpiece can be accessed for removal through a door 36 in the sidewall of the enclosure 50. The computer controls 60 are also conveniently located on the enclosure.

What is claimed is:

1. A method for cutting or welding a workpiece comprising the steps of:
providing a workpiece impinging a focused laser beam on the workpiece to effect a cut or weld; and
providing relative movement between the laser beam and the workpiece about at least an X, Y and A axes to effect the cut or weld.

2. The method of claim 1 including the steps of providing relative movement between said laser beam and the workpiece about a B-axis to effect the cut or weld.

3. The method of claim 2 including the steps of providing relative movement between said laser beam and workpiece about a Z-axis to focus the beam.

4. The method of claim 1 including the steps of providing relative movement between said laser beam and workpiece about a B-axis to effect the cut or weld.

5. Multi-axis cutting or welding apparatus comprising:
laser beam means for cutting or welding a workpiece in a defined pattern, means for holding and moving said workpiece along at least a linear and a rotary axis relative to said laser beam, means for controlling the movement of said workpiece holding and movement means relative to said beam to effect the cut or weld in defined pattern in said tube, and means for moving said beam relative to said workpiece, including means for controlling the movement of the beam.

6. Apparatus in accordance with claim 5 wherein said means for controlling the movement of said workpiece holding and movement means relative to said beam controls movement thereof about an X and Y axis.

7. Apparatus in accordance with claim 6 wherein said means for controlling the movement of the beam controls movement thereof about the A-axis.

8. Apparatus in accordance with claim 6 wherein said means for controlling the movement of the beam controls movement thereof about the A and B axes.

9. Apparatus in accordance with claim 6 including
means for focusing said beam on said workpiece, and
means for adjusting said beam focusing means along a Z-axis.

10. Apparatus in accordance with claim 8 including
means for focusing said beam on said workpiece, and
means for adjusting said beam focusing means along a Z-axis.

11. Apparatus in accordance with claim 1 including
an enclosure for said movement and holding means, and
means for creating an evacuated atmosphere in said enclosure.

12. Apparatus in accordance with claim 1 including
an enclosure for said movement and holding means, and
means for creating an inert atmosphere in said enclosure.

13. Apparatus in accordance with claim 1 including
an enclosure for said movement and holding means, and
means for baking the interior of said enclosure.

14. Apparatus in accordance with claim 1 including
an enclosure for said movement and holding means, and
glove means connected and enabling access to the interior of said enclosure.

15. Apparatus in accordance with claim 14 including
means on the enclosure for viewing the interior thereof.

16. A system for cutting or welding a workpiece comprising:
a laser device for impinging a focused laser beam on a workpiece to effect a cut or weld;
a positioning device configured to provide relative movement between the laser beam and the workpiece, including moving the workpiece simultaneously about at least an X, Y, and A axes to effect the cut or weld; and
an optical system coupled to the positioning device for delivering and focusing the laser beam onto the workpiece where the focusing of the laser beam can be used to control a width of the laser beam for precision cutting or welding of the workpiece.

17. A system comprising:
means for cutting or welding a workpiece in a defined pattern;
means for holding and moving said workpiece simultaneously along at least an X, Y, and A axis relative to said laser beam;
means for controlling the movement of said workpiece, said holding and moving means relative to said laser beam to effect the cut or weld in the defined pattern in said tube; and
means for moving said beam relative to said workpiece, including means for controlling the movement of the laser beam.

18. A system according to claim 17 further comprising means for controlling the movement of the laser beam about the A axis.

19. A system according to claim 17 further comprising means for controlling the movement of the laser beam about the A and B axes.

20. A computer executable software stored on a computer readable medium comprising:
program code to cut or weld a workpiece in a defined pattern;
program code to hold and move said workpiece simultaneously along at least an X, Y and A axes relative to said laser beam;
program code to control the movement of said workpiece relative to said laser beam to effect the cut or weld in the defined pattern in said workpiece; and
program code to control the movement of the laser beam.

21. A computer readable medium having codes stored thereon comprising:
code that when executed will cut or weld a workpiece in a defined pattern;
code that when executed will hold and move said workpiece simultaneously along at least an X, Y and A axes relative to said laser beam;
code that when executed will control the movement of said workpiece relative to said laser beam to effect the cut or weld in the defined pattern in said workpiece; and
code that when executed will control the movement of the laser beam.
